(19) United States
(12) Patent Application Publication
(10) Pub. No.: US 2009/0101061 A1
(43) Pub. Date: Apr. 23, 2009

(54) Foldable book place marker

(76) Inventor: Thomas Almodovar, Playa Del Rey, CA (US)

Correspondence Address: Cislo & Thomas LLP, 1333 2nd Street, Suite #500, Santa Monica, CA, 90401-4110, US

(21) Appl. No.: 11/975,496

(22) Filed: Oct. 19, 2007

(51) Int. Cl. B42D 9/00

(52) U.S. Cl. 116/235

(57) ABSTRACT

A bookmark that indicates the exact last line of text read on a desired page of text or a specific location on a page where it is placed. The flap is hooked on the top of either face of a left or right page, over any column of text, over any image or a specific area to mark it for easy location at another time. The bookmark, utilizes two parts: a body with a folded section and an indicator with an indicia printed on it, which are used to indicate a location on the page. The body is a printed paper or a thin strip of material, of varying lengths, which has a top flap that folds over the top of a page to secure its vertical location on a that page. The indicator with indicia may have two horizontal parallel vertically aligned slits cut at a small distance apart, which allows for the body to be interwoven through the indicator which allows the indicator to stay attached to the body yet still able to be manually slid vertically up and down on the body to an exact position to indicate a location on a page where it will remain until it is manually reset. The bookmark may be adjustable to fit any size of reading material.

### TECHNICAL FIELD

The present invention is an advancement in the area of bookmarks with a particular reference to bookmarks that are capable of indicating both a certain page as well as a specific location of text or image on a page.

### BACKGROUND ART

Bookmarks have been used for many years in locating a particular page in a book. Some bookmarks are more sophisticated incorporating certain features that identify a specific column on a page and even a particular line in that column, for example, by using an indicating arrow that is rotatably and slidably mounted in a slot in the center of the bookmark. The bookmark is first placed on the desired page and the arrow rotated to face towards either the right or left to thus indicate the desired column. The arrow is then slid either upwardly or downwardly in the slot to align it with a particular line. Another bookmark includes two sets of indicia one representing either the left-hand or right-hand page of an opened book, and the other representing the desired column on the particular page. The indicator is then slid into alignment with a particular line on the desired page and column.

These above-mentioned bookmarks themselves are not maintained in their original place on the page. In other words, when the user opens the book, the mark may have shifted and moved out of place, thereby losing the exact place that the mark originally indicated. Thus, these aforementioned bookmarks are not reliable as they may shift during transportation of the book or when the book is otherwise moved or opened.

Therefore, a need exists for an improved bookmark that is easy to use, that stays in position on the page, that will indicate the desired page as well as the desired line or image on that page, and that is not dependent on which side of the page the bookmark faces when the book is opened or whether the book has page numbers or column numbers.

### DISCLOSURE OF INVENTION

The present invention is directed towards an improved bookmark that indicates the exact last line of text read on a particular page of text, or a specific location on a page where it is placed. The improved bookmark comprises a body, a flap, and an indicator. The body marks the desired page. The flap is hooked on the top of either face of a left or right page of a bound multi-paged object such as a book, multi-paged brochure, pamphlet, or other similar object, over any column of text, over any image or over any specific area to secure the vertical positioning of the body and mark the desired page (left or right) for easy location at a later time. The indicator marks the desired line number on the page.

### BRIEF DESCRIPTION OF DRAWINGS

FIG. 1 is front view of an embodiment of the current invention;

FIG. 2 is a rear view of an embodiment of the current invention;

FIG. 3 is a front view of an embodiment of the current invention;

FIG. 4 is a front view of an embodiment of the current invention with an indicator;

FIG. 5 is a top view of the embodiment shown in FIG. 4 cut along the line 5-5;

FIG. 6 is a front view of the indicator;

FIG. 7 is a front view of an embodiment of the current invention;

FIG. 8 is a perspective view of another embodiment of the current invention;

FIG. 9 is a side view of the embodiment shown in FIG. 7 cut along line 9-9.

### BEST MODE FOR CARRYING OUT THE INVENTION

The detailed description set forth below in connection with the appended drawings is intended as a description of presently-preferred embodiments of the invention and is not intended to represent the only forms in which the present invention may be utilized. The description sets forth the functions and the sequence of steps for operating the invention in connection with the illustrated embodiments. However, it is to be understood that the same or equivalent functions and sequences may be accomplished by different embodiments that are also intended to be encompassed within the spirit and scope of the invention.

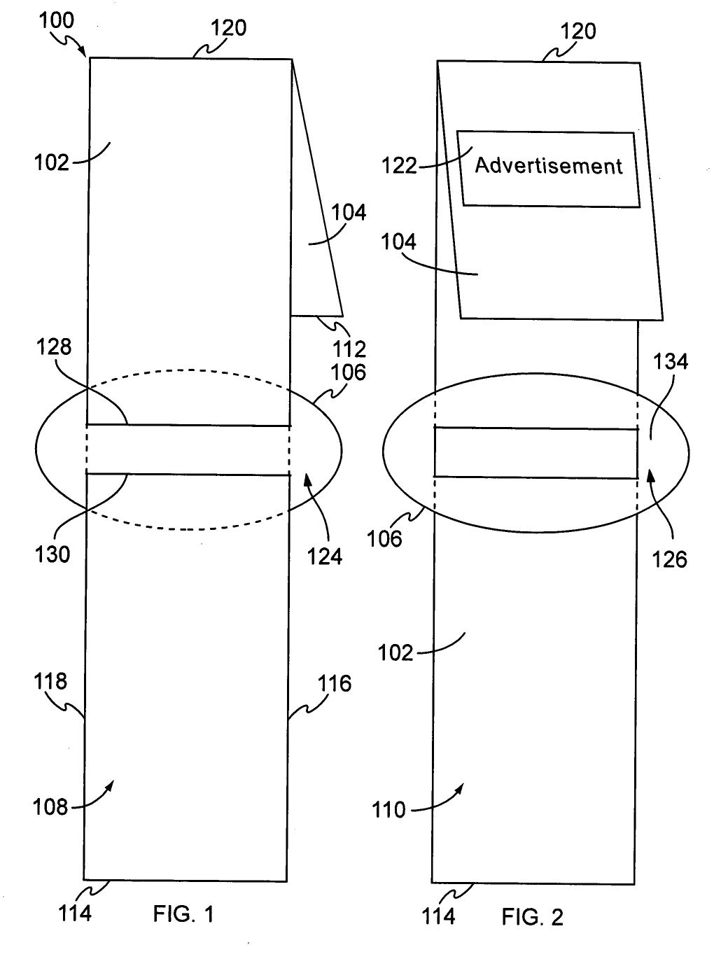

Referring to FIG. 1, a bookmark 100 within the scope of the present invention comprises a body 102, a flap 104 and an indicator 106. The body 102 is a thin member having a first face 108, a second face 110 opposite the first face 108 (as shown in FIG. 2), a top perimeter edge 112, a bottom perimeter edge 114, a first side edge 116 adjacent to the top and bottom perimeter edges, and a second side edge 118 opposite the first side edge 116, wherein the first side edge 116 and the second side edge 118 define a width. Preferably, the body 102 is narrower than the width of the reading material, and shorter than the height of the reading material. The body 102, however, may be taller than the height of the reading material.

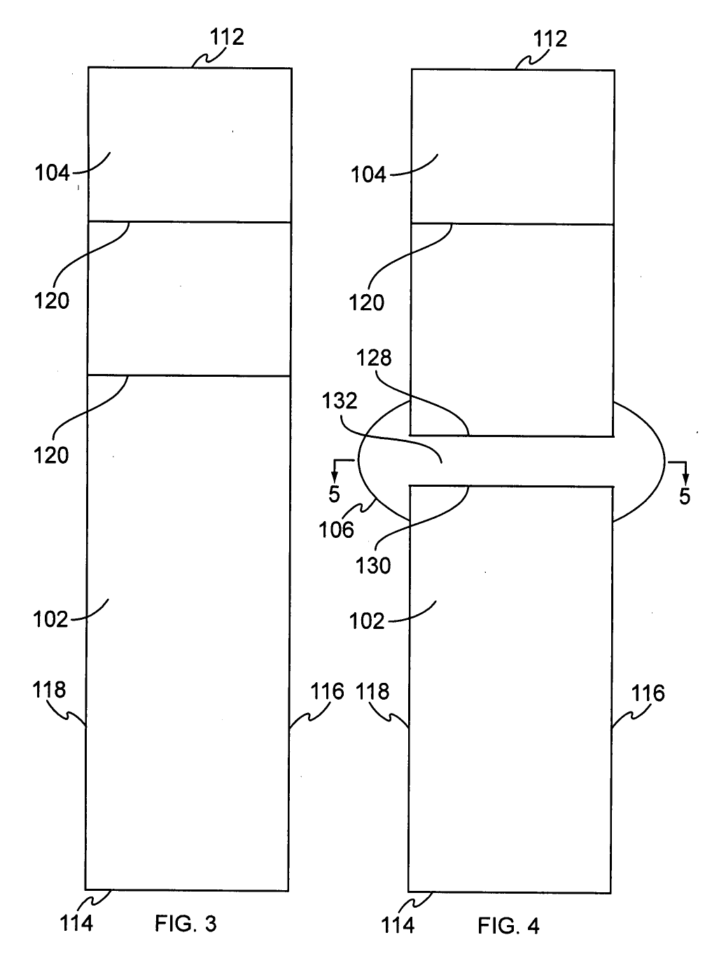

In some embodiments, the body 102 may have a fold 120 or a plurality of folds 120, as shown in FIG. 3, such that the length of a bookmark 100 may be adjustable to fit any size book. Thus, the bookmark 100 may be folded back onto itself at the folds 120 thereby decreasing the length of the bookmark 100 so as to conform to the size of the book.

A fold 120 at the top of the body 102 defines a flap 104 that folds over the top of a page to secure a vertical location of the bookmark 100 on the page. For example, while the body 102 of the bookmark 100 is placed on the page the user desires to return to at a later time, the flap 104 may be folded over the top of the page and sandwiched between the page the user desires to return to and the subsequent page or the previous page. This reduces the probability of losing the user's place when the book is opened or transported. Specifically, it is unlikely for the bookmark 100 to be vertically displaced because even if the bookmark 100 slides laterally across the page, the vertical location is maintained by the flap 104. With the body 102 wedged into the bound edge of a book and the flap 104 hooked at the top of the page, it is highly unlikely for any kind of unwanted displacement of the bookmark 100 to occur. Thus, the flap 104 does not require a biasing force to secure the flap 104 to the page, where the biasing force could result in deformed or damaged pages.

The flap 104 may be hooked on the top of either face of a left or right page without having to change the orientation of the bookmark 100, such as by inverting the bookmark 100. In addition, the bookmark 100 may be positioned over any column of text, over any image, or over any specific area to mark it for easy location at another time. Since the flap 104 does not employ a biasing force to maintain its position, the bookmark 100 can be slid laterally by the user while the reading material is open. This will not only allow the user to vertically mark the desired line but also laterally mark the beginning of the desired sentence.

As shown in FIG. 2, the flap 104 and/or the body 102 may further have a message 122 printed, attached, inscribed, engraved or otherwise placed on it. The message 122 may be an advertisement, promotion, information, ornamentation, designs, logos or other markings that may be informative, entertaining, or aesthetically pleasing. In addition, the flap 104 may be any shape or design. For example, for children, the flap 104 may be in the shape of an animal or a cartoon character.

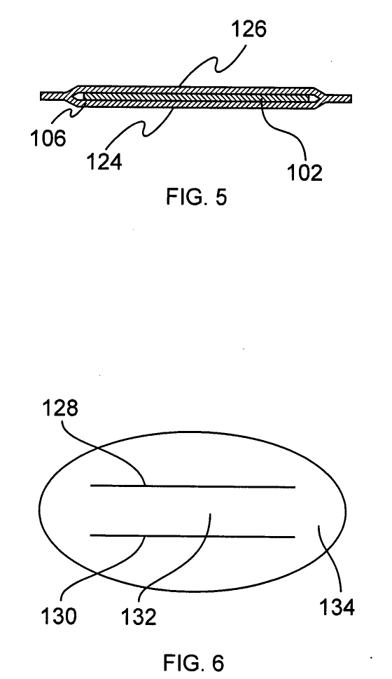

As shown in FIGS. 5 and 6, the indicator 106, which is used to designate a desired line or location on the page, such as the last line on the page read by the user, is a thin piece of material comprising a first surface 124 and a second surface 126 opposite the first surface 124. In some embodiments, the indicator 106 is slidably mounted on the body 102. To accomplish this, the indicator 106 may have a first slit 128 and a second slit 130, thereby defining a transverse strip 132 and a backing 134. The first and second slits 128, 130 are slightly wider than the width of the body 102 to allow the indicator 106 to slidably mount on to the body 102 by inserting the body 102 through the first and second slits 128, 130 of the indicator 106 between the transverse strip 132 and the backing 134. This arrangement causes the transverse strip 132 to apply a force against the body 102 in one direction and causes the backing 134 to apply a second force against the body 102 in the opposite direction, thereby creating a resistive force between the transverse strip 132 and the body 102 as well as between the backing 134 and the body 102. This resistive force helps maintain the indicator 106 at the desired location and reduces the chance of the indicator 106 slipping out of place. In addition, contact between the surface areas of the transverse strip 132 and the body 102 as well as the backing 134 and the body 102 create a frictional force to reduce undesired movement of the indicator 106 along the body 102.

The slits 128, 130 may be two horizontal parallel vertically aligned slits cut at a small distance apart, which allows for the body 102 to be interwoven through the indicator 106, thereby allowing the indicator 106 to stay attached to the body 102 while maintaining the ability to be manually slid up and down on the body 102 to an exact position to indicate a location on a page where it will remain until it is manually reset.

Other means for movably or removably attaching or mounting the indicator 106 to the body 102 may be used. For example, the indicator 106 may have a single horizontal or transverse slit slightly larger than the width of the body 102, thereby dividing the indicator 106 into a top portion and a bottom portion. Sliding the body 102 through the single slit will cause the top portion of the indicator 106 to apply a force in a first direction on the body 102 and the bottom portion of the indicator 106 to apply a force on the body 102 in a second and opposite direction, thereby creating a resistive force between the indicator 106 and the body 102.

In other embodiments, a single slit slightly larger than the body 102 may penetrate through the thickness of the indicator thereby forming a collar. In other embodiments, the body 102 may have vertical slits and the indicator 106 may be slid in between the vertical slits of the body 102. In some embodiments, the indicator 106 may have resistive tabs that can be slid into the vertical slits of the body 102. In some embodiments, the indicator 106 may be removably attached to the body 102, for example, using the hook and loop, static charge, magnets, adhesives, or other attachment means that allow for quick and easy attachment and detachment.

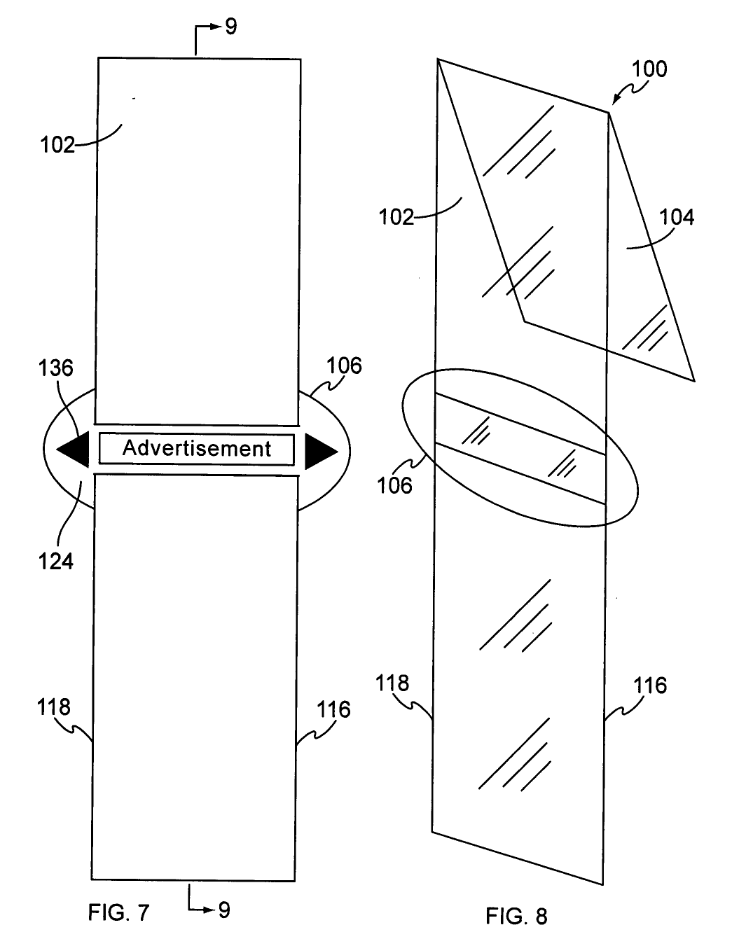

As shown in FIG. 7, the indicator 106 may further have an indicia 136 on one of the surfaces of the indicator 106. The indicia 136 may be any type of marking such as straight lines, arrows, pictures, or the like. The indicia 136 may be printed, etched, engraved, affixed, or otherwise attached to the indicator 106. In some embodiments, an indicia 136 may be on the first surface 124 and a second indicia may be on the second surface 126 (shown in FIG. 2), thereby making the bookmark 100 reversible. In some embodiments, the bookmark 100 may have a plurality of indicia 136 on the same side.

As shown in FIG. 7, the transverse strip 132 on indicator 106 may have a message 122 printed, attached, inscribed, engraved or otherwise placed on it. The message 122 may be an advertisement, promotion, information, ornamentation, designs, logos or other markings that may be informative, entertaining, or aesthetically pleasing.

In embodiments with slidable indicators 106, the indicator 106 may further comprise a securing member to help secure the indicator 106 in place. For example, the first and second side edges 116, 118 may have notches or slits located longitudinally along the entire edge. The indicator 106 or the transverse strip 132 may be inserted into the notch or slit to secure placement at that location.

The body 102 and the indicator 106 may be constructed of any material such as metal, plastic, wood, paper, and the like. In some embodiments, as shown in FIG. 8, the body 102 and the indicator 106 may be transparent. In such embodiments, the user can see through the bookmark 100 and read the reading material. In transparent embodiments coupled with a slidable indicator, the user can align the indicia 136 with the line of text being read and slide the indicator 106 down while the user reads the subsequent lines so as not to lose his or her place while reading. If the user is interrupted, the user can quickly and easily find his or her place as the indicator would indicate where the user left off just prior to being interrupted. Thus, the bookmark may be used for indicating a line on a page of a bound multi-paged object by securing a bookmark on the desired page, such that a vertical displacement is substantially prevented, wherein the bookmark comprises a body and an indicator, and sliding the indicator to the desired line. The user may further track a plurality of lines by sliding the indicator down as the user transitions from a first line to a second line, then secure the indicator in place at last line read when the user is ready to stop.

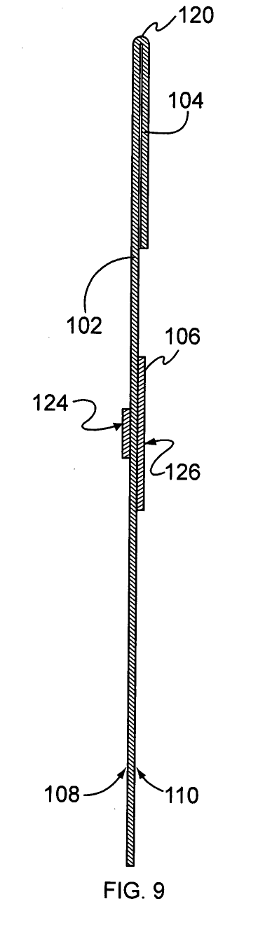

The material utilized to construct the bookmark 100 should generally be thin as shown in FIG. 9. Even in FIG. 9, the thickness of the bookmark 100 has been grossly exaggerated so as to clearly show the proper structural arrangement. In reality, the bookmark 100 can be as thin as a sheet of paper. To increase strength and sturdiness, the bookmark may be thicker than a sheet of paper.

On the other hand, protruding members that could deform the internal structure of the bound multi-paged object or a reading material if the object or reading material is closed upon the protruding member should be avoided. Utilizing thin material and slits as opposed to protruding members minimizes or prevent indentations, deformations, and damage to the pages while the bookmark 100 remains inside the reading material, even when closed. Other bookmarks that have any significant thickness or other modes of attaching to the reading material have greater potential for indenting, creasing, ripping, or otherwise damaging the reading material.

While the present invention has been described with regards to particular embodiments, it is recognized that additional variations of the present invention may be devised without departing from the inventive concept.

### INDUSTRIAL APPLICABILITY

This invention may be industrially applied to the development, manufacture, and use of bookmarks that can be secured in place both vertically and horizontally and designate a specific page and line of a reading material.

What is claimed is:

1. A bookmark for indicating a line on a page of a bound multi-paged object, comprising:
(a) a body comprising a first face, a second face opposite the first face, a top perimeter edge, a bottom perimeter edge, a first side edge adjacent to the top and bottom perimeter edges, and a second side edge opposite the first side edge, wherein the first side edge and the second side edge define a width;
(b) a flap defined by a fold on the body; and
(c) a means for movably mounting an indicator on the body, wherein the indicator comprises a first surface and a second surface.

2. The bookmark of claim 1, wherein the flap further comprises a message.

3. The bookmark of claim 2, wherein the message is an advertisement.

4. The bookmark of claim 1, wherein the indicator comprises a first slit and a second slit, thereby defining a transverse strip and a backing, wherein the first and second slits are wider than the body so as to slidably mount the indicator on to the body by inserting the body through the first and second slits of the indicator between the transverse strip and the backing.

5. The bookmark of claim 4, wherein the indicator further comprises an indicia on the first surface to indicate the line on the page.

6. The bookmark of claim 5, wherein the indicator further comprises a second indicia on the second surface such that the bookmark is reversible.

7. The bookmark of claim 4, wherein the transverse strip comprises a message.

8. The bookmark of claim 7, wherein the message is an advertisement.

9. The bookmark of claim 1, wherein the body and the indicator are transparent.

10. A bookmark for indicating a line on a page of a bound multi-paged object, comprising:
(a) a body comprising a first face, a second face opposite the first face, a top perimeter edge, a bottom perimeter edge, a first side edge adjacent to the top and bottom perimeter edges, and a second side edge opposite the first side edge, wherein the first side edge and the second side edge define a width;
(b) a flap for securing the body onto the bound multi-paged object; and
(c) an indicator slidably mounted on the body.

11. The bookmark of claim 10, wherein the flap further comprises a message.

12. The bookmark of claim 11, wherein the message is an advertisement.

13. The bookmark of claim 10, wherein the indicator comprises an indicia to indicate the line on the page.

14. The bookmark of claim 13, wherein the indicator comprises a first slit and a second slit, thereby defining a transverse strip and a backing, wherein the first and second slits are wider than the width of the body so as to slidably mount the indicator on to the body by inserting the body through the first and second slits of the indicator between the transverse strip and the backing.

15. The bookmark of claim 14, wherein the transverse strip comprises a message.

16. The bookmark of claim 15, wherein the message is an advertisement.

17. The bookmark of claim 10, wherein the body and the indicator is substantially transparent.

18. A method for indicating a line on a page of a bound multi-paged object, comprising:
(a) securing a bookmark on a desired page, such that a vertical displacement is substantially prevented, wherein the bookmark comprises a body and an indicator; and
(b) sliding the indicator to the line on the page.

19. The method of claim 18, wherein the indicator comprises an indicia.

20. The method of claim 19, further comprising aligning the indicia with the line on the page.

21. The method of claim 19, wherein the bookmark is transparent.

22. The method of claim 21, further comprising:
(a) tracking a plurality of lines by sliding the indicator down as a user transitions from a first line to a second line; and
(b) securing the indicator in place at last line read.
